(19) United States
(12) Patent Application Publication
(10) Pub. No.: US 2008/0204816 A1
(43) Pub. Date: Aug. 28, 2008

(54) Image forming system and grayscale characteristics correcting method

(75) Inventor: Koichi Miyazaki, Ebina-shi (JP)

Correspondence Address: OLIFF & BERRIDGE, PLC, P.O. BOX 320850, ALEXANDRIA, VA, 22320-4850, US

(73) Assignee: FUJI XEROX CO., LTD., TOKYO (JP)

(21) Appl. No.: 11/907,609

(22) Filed: Oct. 15, 2007

(30) Foreign Application Priority Data
Feb. 23, 2007 (JP) 2007-043315

(51) Int. Cl. H04N 1/00

(52) U.S. Cl. 358/406

(57) ABSTRACT

An image forming system includes a storing unit that stores a color test pattern made up of a set of test images for grayscale characteristic measurement; a print position setting unit that sets plural positions where the color test pattern stored in the storing unit is printed, based on paper size information supplied thereto; an outputting unit that outputs the color test pattern retrieved from the storing unit in plural positions on a printing medium according to the print positions set by the print position setting unit; a grayscale correction data creating unit that creates grayscale correction data according to results of calorimetric measurements of the test images of plural color test patterns printed on the printing medium; and a grayscale characteristic correction unit that corrects grayscale characteristics of print data to be printed, according to the grayscale correction data created by the grayscale correction data creating unit.

### CROSS-REFERENCE TO RELATED APPLICATIONS

This application is based on and claims priority under 35 USC 119 from Japanese Patent Application No. 2007-043315 filed Feb. 23, 2007.

### BACKGROUND

1. Technical Field

The present invention relates to an image forming system and a grayscale characteristics correcting method.

2. Related Art

Printer engines inevitably experience variation in printing characteristics due to variation in the environment conditions and aging of the printer. To correct such variation, a process for grayscale correction which is called color proof and calibration is performed. The process for grayscale correction prints a color test pattern on paper for printing and makes calorimetric measurements for each patch in the color test pattern to obtain current engine characteristic data. Based on comparison between the thus obtained current engine characteristic data and standard characteristics, the process creates a grayscale correction table (calibration table). Image data to be printed is subjected to grayscale correction using the created grayscale correction table to make the print characteristics when actually printed on printing paper approximating to the standard characteristics. Generally, standard characteristics of prints on plural typical papers (e.g., plain paper and coated paper) supplied or recommended by printer manufacturers are prepared in advance. A color test pattern made up of a set of patches for grayscale characteristic measurement is printed on printing paper in use. Grayscale of each patch (test image) printed is calorimetrically measured and current engine characteristic data on printing on the paper is obtained.

By carrying out such calibration process, variation due to aging in the printer engine part is corrected and grayscale characteristics approximating to the standard characteristics can be obtained. However, printing characteristics are not always uniform everywhere on the paper on which a print is produced. For example, in a case where a photoreceptor drum is not uniformly brought in contact with the printing paper in the fast-scanning direction, an in-plane uneven print occurs. This uneven printing characteristics of image output equipment is corrected by adjustment at the shipment of a printer, but cannot be eliminated completely. Furthermore, variation due to aging and variation in environmental conditions introduce unevenness in the printing.

A problem associated with a printer in which such in-plane uneven print occurs in the printing characteristics is a decrease in accuracy of calibration, because measured calorimetric values differ, depending on the position on paper where the color test pattern is printed. In particular, the in-plane uneven print of the printing characteristics often occurs in the fast-scanning direction. For an image forming apparatus for which only one color test pattern is prepared, although depending on the width of paper selected, it may happen that the color test pattern is not printed in a large region on paper. This results in a low accuracy of calibration.

For example, in the case of cut sheet printers, a color test pattern for a certain size (e.g., for A4 sheets) is prepared as a color test pattern on paper and generally this pattern is printed. In practice, even if the printer is capable to print on sheets of other sizes such as A3 and B4 sheets, printing characteristics only in A4 width are measured, because the color test pattern for A4 sheets only is prepared. Therefore, when printing on an A3 or B4 sheet is performed, even if there is color non-uniformity due to that the printing characteristics differ in both end portions of the sheet, it is not calibrated. This problem, that is, a low accuracy of calibration, arises because the calibration process is performed, based on the color characteristics for A4 sheet width.

### SUMMARY

In order to achieve the foregoing, an image forming system according to an aspect of the invention includes a storing unit that stores a color test pattern made up of a set of test images for grayscale characteristic measurement; a print position setting unit that sets plural positions where the color test pattern stored in the storing unit is printed, based on paper size information supplied thereto; an outputting unit that outputs the color test pattern retrieved from the storing unit in plural positions on a printing medium according to the print positions set by the print position setting unit; a grayscale correction data creating unit that creates grayscale correction data according to results of calorimetric measurements of the test images of plural color test patterns printed on the printing medium; and a grayscale characteristic correction unit that corrects grayscale characteristics of print data to be printed, according to the grayscale correction data created by the grayscale correction data creating unit.

### BRIEF DESCRIPTION OF THE DRAWINGS

Exemplary embodiments of the present invention will be described in detail based on the following figures, wherein:

FIG. 1 is a block diagram showing a configuration of an image forming system according to a first exemplary embodiment of the invention;

FIG. 2 is a block diagram showing an outline structure of a printing apparatus 1 in the first exemplary embodiment of the invention;

FIG. 3 is a diagram showing a configuration of functions of the printing apparatus 1 in the first exemplary embodiment of the invention;

FIG. 4 illustrates one example of a color test pattern 41 that is generated by a color test pattern generating part 31;

FIG. 5 illustrates one example of color test pattern print positions set by a print position setting part 33;

FIG. 6 illustrates another example of color test pattern print positions set by the print position setting part 33;

FIG. 7 illustrates yet another example of color test pattern print positions set by the print position setting part 33;

FIG. 8 illustrates another example of color test pattern print positions set by the print position setting part 33;

FIG. 9 illustrates still another example of color test pattern print positions set by the print position setting part 33;

FIG. 10 is a flowchart for explaining a method for creating a calibration table based on colorimetric values of patches of plural color test patterns;

FIG. 11 is a graphical representation showing a relationship between the calorimetric values of three color test pattern patterns 71, 72, 73 and an average thereof;

FIG. 12 illustrates an example of a color test pattern used in an image forming system according to a second exemplary embodiment of the invention; and

FIG. 13 illustrates another example of color test patterns used in the image forming system according to the second exemplary embodiment of the invention.

### DETAILED DESCRIPTION

In the following, exemplary embodiments of the present invention will be described in detail with reference to the drawings.

### First Exemplary Embodiment

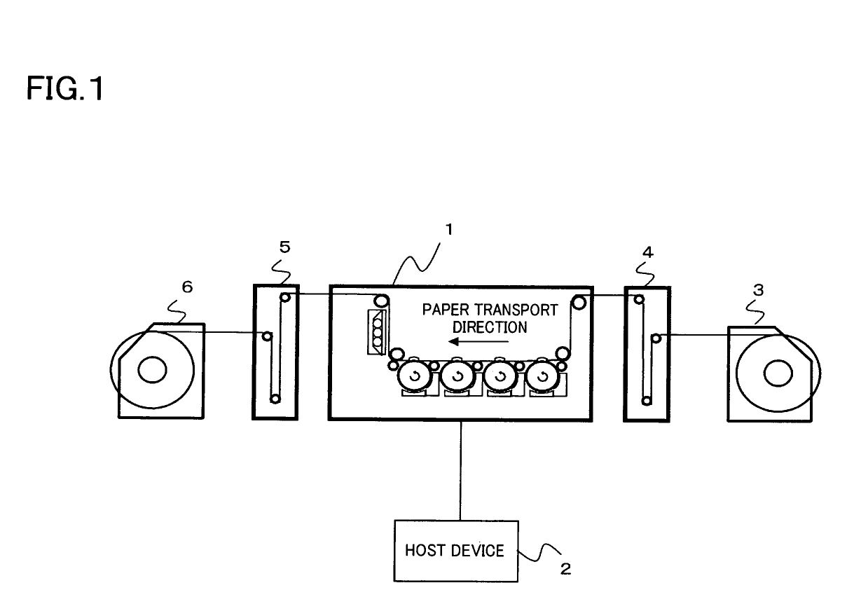

FIG. 1 is a diagram showing an example of a configuration of an image forming system according to a first exemplary embodiment of the invention. As shown in FIG. 1, this image forming system is composed of a pre-processing device 3, a buffer device 4, a printing apparatus 1, a buffer device 5, and a post-processing device 6. In the present exemplary embodiment, the printing apparatus 1 that prints on continuous forms paper is illustrative of the image forming apparatus inherent in the invention.

The pre-processing device 3 performs pre-processing such as feeding of printing paper on which nothing has been printed. The post-processing device performs post-processing such as winding of printing paper on which printing has been finished. The buffer devices 4, 5 are provided between the pre-processing device 3 and the printing apparatus 1 and between the printing apparatus 1 and the post-processing device 6, respectively, to maintain the tension of the printing paper.

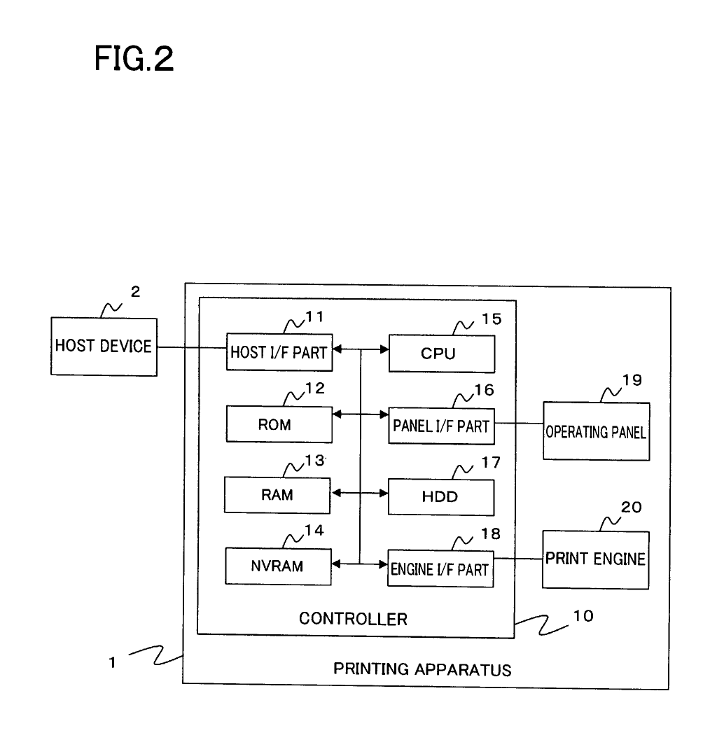

Then, an outline structure of the printing apparatus 1 in the first exemplary embodiment of the invention is described with reference to FIG. 2. As shown in FIG. 1, the printing apparatus 1 in the present exemplary embodiment is composed of a controller 10, an operating panel 19, and a print engine (print mechanism part) 20.

The print engine 20 is a mechanism for actual printing on printing paper. The operating panel 19 is a unit by which a command is input from an operator, a user, or the like and notification to the operation or user is displayed.

The controller 10 is composed of a host I/F part 11, a ROM 12, a RAM 13, a NVRAM (Non-Volatile RAM) 14, a CPU 15, a panel I/F part 16, an HDD 17, and engine I/F part 18.

The host I/F part 11 serves for communication with the host device 2. The engine I/F part 18 serves for communication with the print engine 20. The panel I/F part 16 serves for communication with the operating panel 19.

The ROM 12, RAM 13, NVRAM 14, HDD 17, etc. are used to store various kinds of data such as control programs and print data. The CPU 15 is responsible for control of the host I/F part 11, ROM 12, RAM 13, NVRAM 14, panel I/F part 16, HDD 17, and engine I/F part 18.

The controller 10, as shown in FIG. 2, is a general-purpose computer in which a particular process is executed by the CPU 15 in accordance with a print control program. This print control program is read from a storage medium such as the ROM 12 or HDD 17 and installed into the CPU 15 to control the operation of the printing apparatus 1.

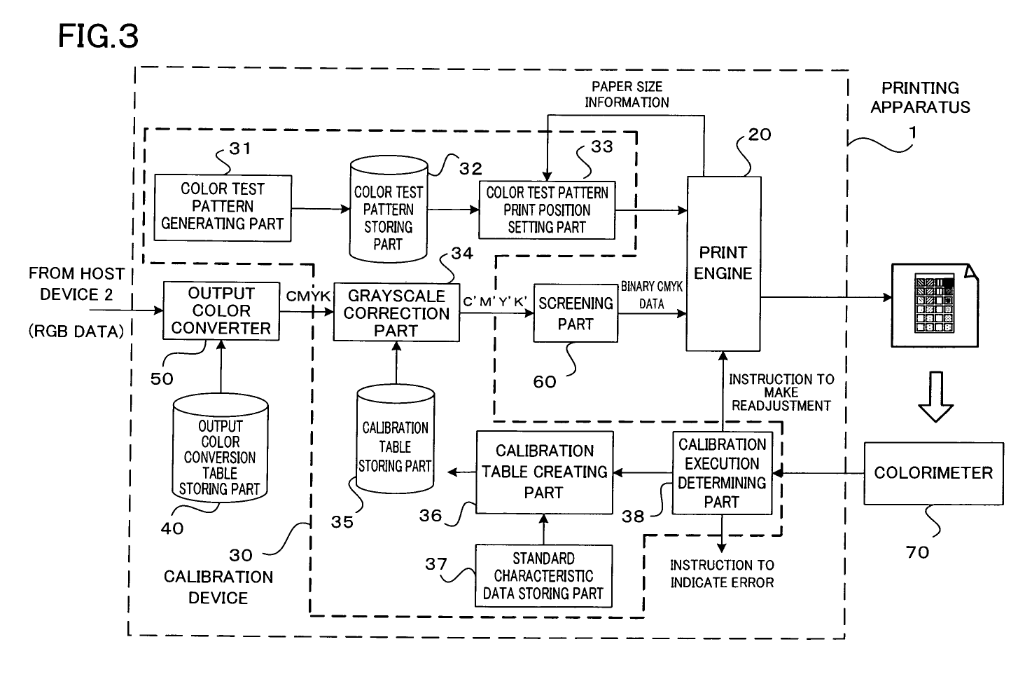

FIG. 3 is a diagram illustrating a configuration of functions of the printing apparatus 1, which are realized by execution of the above print control program.

As shown in FIG. 3, the printing apparatus 1 in the present exemplary embodiment includes a print engine 20, a calibration device 30, an output color conversion table storing part 40, and output color converter 50, and a screening part 60.

The calibration device 30 is composed of a color test pattern generating part 31, a color test pattern storing part 32, a color test pattern print position setting part 33, a grayscale correction part 34, a calibration table storing part 35, a calibration table creating part 36, a standard characteristic data storing part 37, and a calibration execution determining part 38.

The output color conversion table storing part 40 stores a color conversion table for conversing RGB image data into CMYK image data. The output color converter 50 converts RGB image data that has been input from the host device 2 into CMYK image data, according to the color conversion table stored in the output color conversion table storing part 40.

The color test pattern generating part 31 generates a color test pattern made up of a set of patches (test images) for grayscale characteristic measurement. The color test pattern storing part 32 stores the color test pattern generated by the color test pattern generating part 31

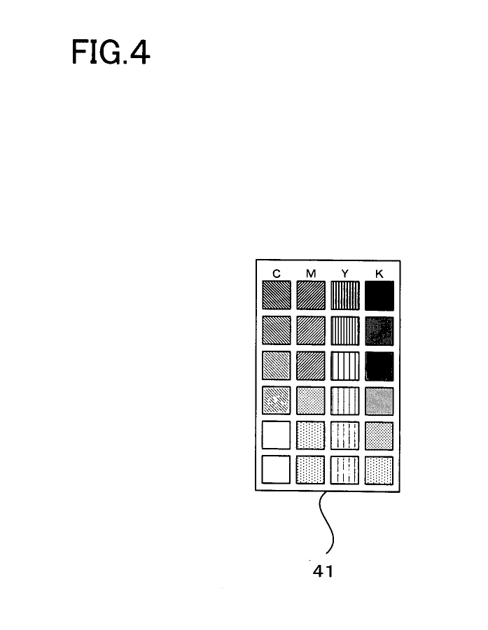

Then, an example of a color test pattern 41 that is generated by the color test pattern generating part 31 is shown in FIG. 4. In the example of the color test pattern 41 shown in FIG. 4, there are six patches with different density levels for each of CMYK colors.

The color test pattern print position setting part 33 sets plural positions where a color test pattern stored in the color test pattern storing part 32 is printed, based on paper size information supplied from the print engine 20. In the standard characteristic data storing part 37, standard characteristic data that has been set in advance is stored.

The calibration table creating part 36 creates a calibration table (grayscale correction data) according to results of calorimetric measurements of the patches of plural color test patterns, which have been printed on printing paper, with a colorimeter 70. In particular, the calibration table creating part 36 calculates an average of the calorimetric values of the patches of plural color test patterns printed on printing paper measured with the colorimeter 70 and creates a calibration table so as to correct a difference between the calculated average of the colorimetric values and the standard characteristic data stored in the standard characteristic data storing part 37.

As a concrete example of a calorimetric value measured with the colorimeter 70, ΔE that represents a distance between two colors in the L*a*b color system can be used.

For example, given that a foreseen measurement value of white printing paper is (Lp, ap, bp) and a measurement value of a patch measured with the calorimeter 70 is (Lx, ax, bx), a colorimetric value of the patch is ΔE that is calculated by the following equation:

ΔE=√((Lx−Lp)²+(ax−ap)²+(bx−bp)²)

ΔE is measured for each patch included in a color test pattern.

The calibration execution determining part 38 takes input of the calorimetric values of the patches measured with the colorimeter 70 and determines whether to execute calibration (grayscale correction), based on the results of calorimetric measurements of plural patches, each of which should be a uniform color. In particular, the calibration execution determining part 38 takes input of the calorimetric values of the patches measured with the colorimeter 70 and determines whether to execute calibration, based on the difference between an average of the calorimetric values of plural patches, each of which should be a uniform color, and the standard characteristic data.

For example, if the difference between an average of the colorimetric values of the patches of plural color test patterns and the standard characteristic data is equal to or greater than a predetermined value, the calibration execution determining part 38 determines that calibration should not be executed. In other words, if there is too large a difference between the average of the colorimetric values of the patches and the standard characteristic data, the calibration execution determining part 38 determines that the difference exceeds the scope in which it is correctable by calibration and determines that adjustment or the like of the print engine 20 should be performed.

If the difference between an average of the calorimetric values of the patches of plural color test patterns and the standard characteristic data is equal to or greater than a predetermined value A or less than a value B, the calibration execution determining part 38 may determine that calibration should not be executed. Here, as a matter of course, value A is greater than value B. In this case, the average of the colorimetric values of the patches is compared to value A because of the same reason as noted above. If the average of the calorimetric values of the patches is less than value B, the calibration execution determining part 38 determines that it is unnecessary to execute calibration because of so small a difference between the current printing characteristics and the standard characteristics. In other words, since actual printing characteristics in the present state are enough approximate to the standard characteristics, the determining part determines that it is not needed to adapt the printing characteristics by executing calibration.

Further, if difference across the calorimetric values of the patches of plural color test patterns is equal to or greater than a predetermined value, the calibration execution determining part 38 may determine that calibration should not be executed. In this case, the reason is that too large variation across the colorimetric values of the patches indicates any fault in the print engine 20 such as a skewed photoreceptor drum and it is anticipated that desired printing characteristics cannot be achieved by calibration based on the average of the colorimetric values. As an example of a concrete way of determination, the calibration execution determining part 38 makes this determination depending on whether the difference between a maximum value and a minimum value of the calorimetric values of plural patches, each of which should be a uniform color, is equal to or greater than a predetermined value.

If, by the calibration execution determining part 38, it is determined that calibration should be executed, the calibration table creating part 36 creates a calibration table.

The calibration table storing part 35 stores the calibration table created by the calibration table creating part 36.

The grayscale correction part 34 corrects the grayscale characteristics of print data in which color data has been converted by the output color converter 50, according to the calibration table stored in the calibration table storing part 35.

The screening part 60 converts multilevel image data after being calibrated (grayscale corrected) by the grayscale correction part 34 into binary image data.

For normal printing, the print engine 20 prints the binary image data resulting from screening by the screening part 60 on printing paper. When calibration is executed, the print engine 20 prints the color test pattern retrieved from the color test pattern storing part 32 in plural positions on the printing paper according to the print positions set by the color test pattern print position setting part 33.

Then, a concrete method of setting print positions for the color test pattern by the color test pattern print position setting part 33 is explained in detail.

The color test pattern print position setting part 33 sets print positions so that the color test pattern as shown in FIG. 4 is printed in plural print positions where prints are expected to have different printing characteristics. The color test pattern print position setting part 33 sets print positions for the color test pattern so that more color test patterns are printed in proportion as paper size becomes larger.

In general, it is expected that variation in printing characteristics across the width direction of paper is larger than variation in printing characteristics in the paper transport direction. Therefore, the color test pattern print position setting part 33 sets print positions of plural color test patterns so that the printing characteristics in different positions across the width direction of paper will be measured.

Here, in a case where the print engine 20 applies an electrophotographic printing method and a laser light source is used as the light source, the width direction of paper represents the fast-scanning direction and the width direction of paper (paper transport direction) represents the slow-scanning direction.

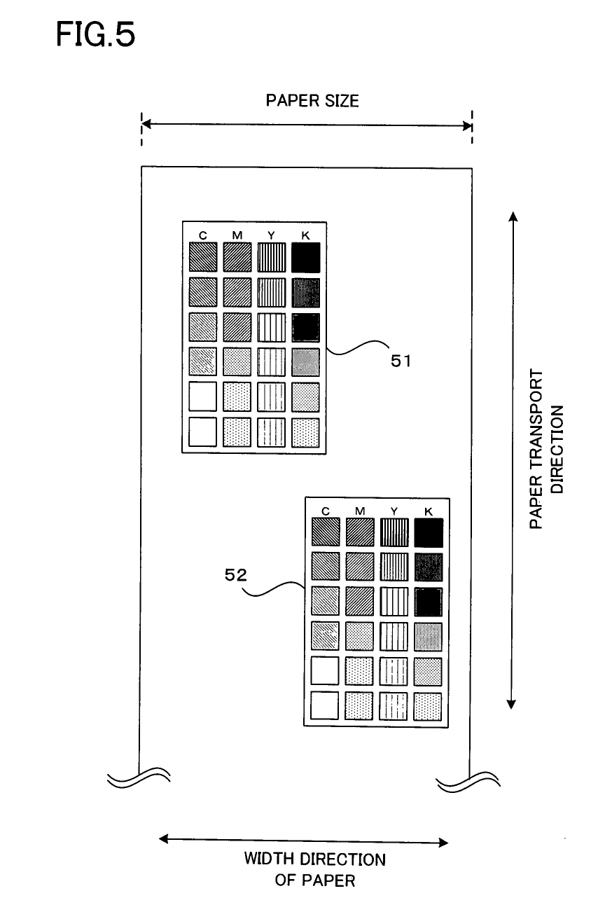

If two color test patterns cannot be positioned side by side across the width direction of paper because of paper size, for example, as illustrated in FIG. 5, the color test pattern print position setting part 33 arranges the two color test patterns 51, 52, one being off-center to one side and the other being off-center to the other side, in the paper transport direction.

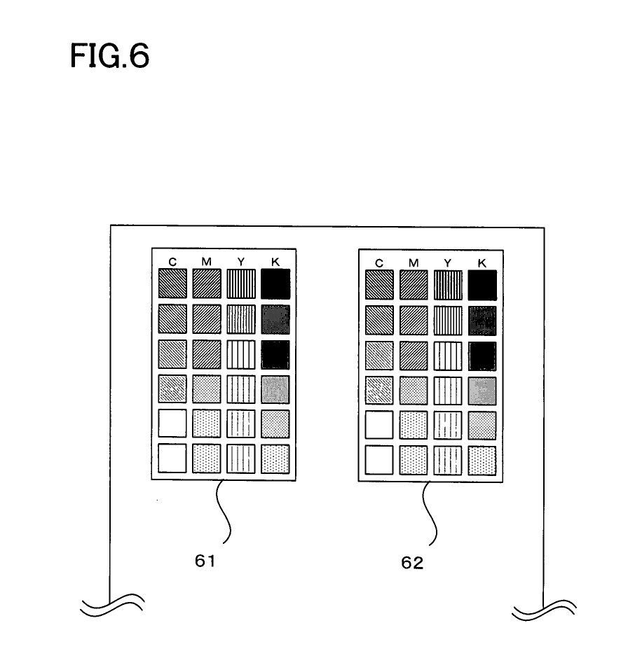

If two color test patterns can be positioned side by side across the width direction of paper because of paper size, for example, as illustrated in FIG. 6, the color test pattern print position setting part 33 may arrange the two color test patterns 61, 62 side by side.

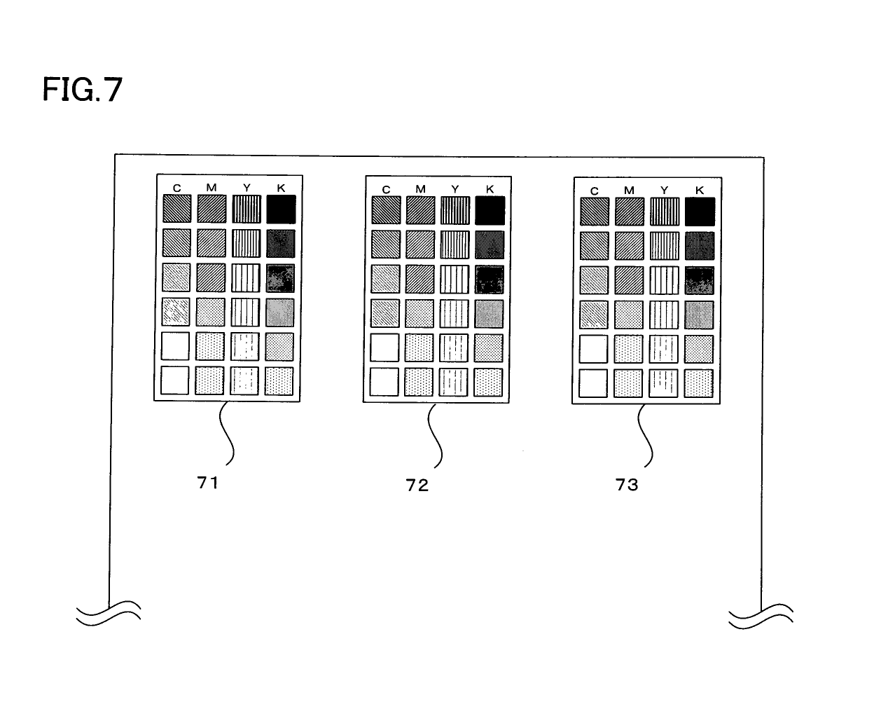

Further, if three color test patterns can be positioned side by side across the width direction of paper because of paper size, for example, as illustrated in FIG. 7, the color test pattern print position setting part 33 may arrange the three color test patterns 71, 72, 73 side by side.

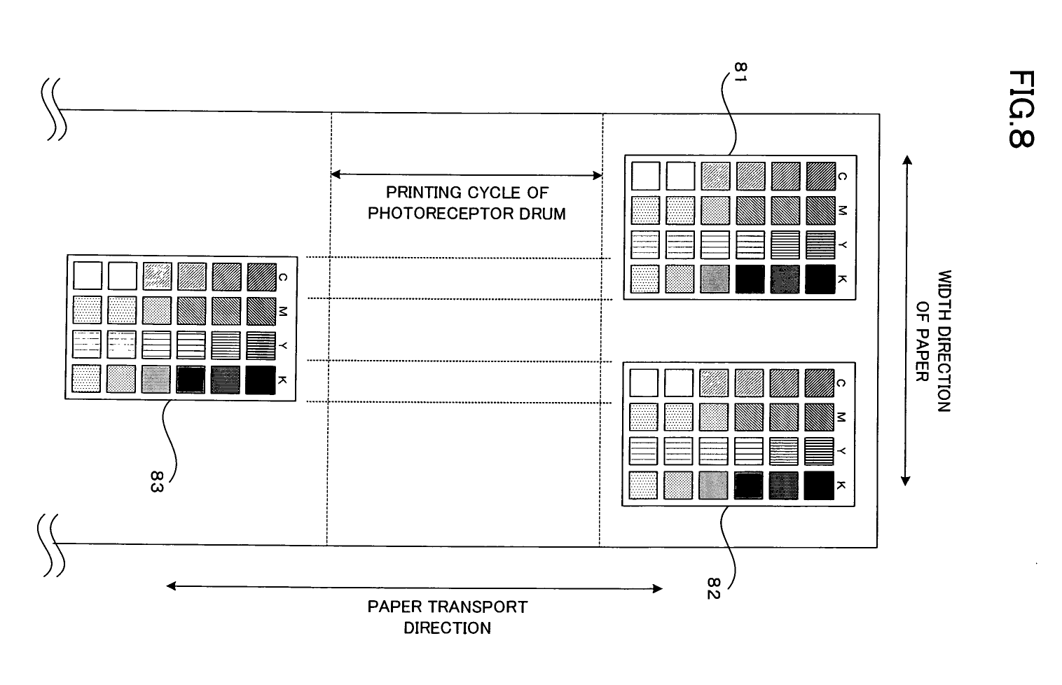

If plural color test patterns are positioned side by side and there remains some margin in either side, another color test pattern may be positioned off center to the opposite side to the test patterns arranged side by side and arranged in the following position in the paper transport direction. If two color test patterns 81, 82 can be positioned side by side across the width direction of paper, but a third color test pattern cannot be done so, for example, as illustrated in FIG. 8, the color test pattern print position setting part 33 may position the third color test pattern 83 in a backward position in the paper transport direction corresponding to a blank space between the color test patterns 81, 82 arranged side by side. In this way, printing characteristics in three places across the width direction of paper can be measured.

If color test patterns arranged in the paper transport direction overlap in the width direction, the image lags of the preceding color test patterns 81 and 82 may affect the printing characteristics of the image of the subsequent color test pattern 83. In such case, the color test pattern print position setting part 33 positions the subsequent color test pattern 83 after a certain interval from the preceding patterns overlapping with it in the paper transport direction, the interval being larger than a printing cycle of the print engine 20 (a printing cycle of the photoreceptor drum).

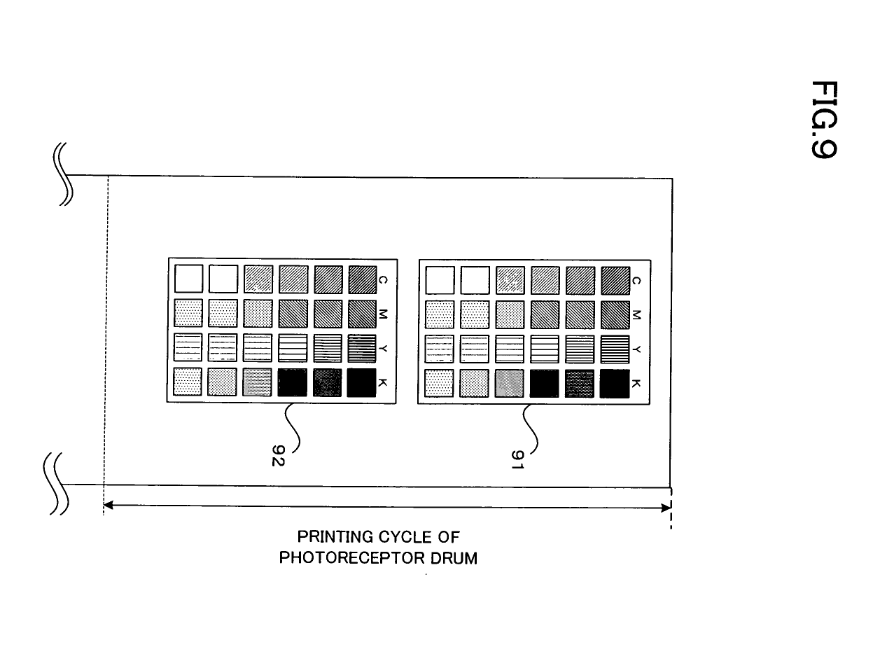

If the printing characteristics are anticipated to vary largely in the paper transport direction, the color test pattern print position setting part 33 may set print positions of plural color test patterns so that the printing characteristics in different positions in the paper transport direction will be measured. This variation in the printing characteristics in the paper transport direction is considered to occur within a cycle of the photoreceptor drum. Therefore, the color test pattern print position setting part 33 positions two color test patterns 91, 92 to allow the measurement of the printing characteristics in two places within a cycle of the photoreceptor drum in the paper transport direction, for example, as illustrated in FIG. 9.

The color test pattern print position setting part 33 may also position color test patterns so that the printing characteristics in plural places in both the width direction of paper and the paper transport direction can be measured.

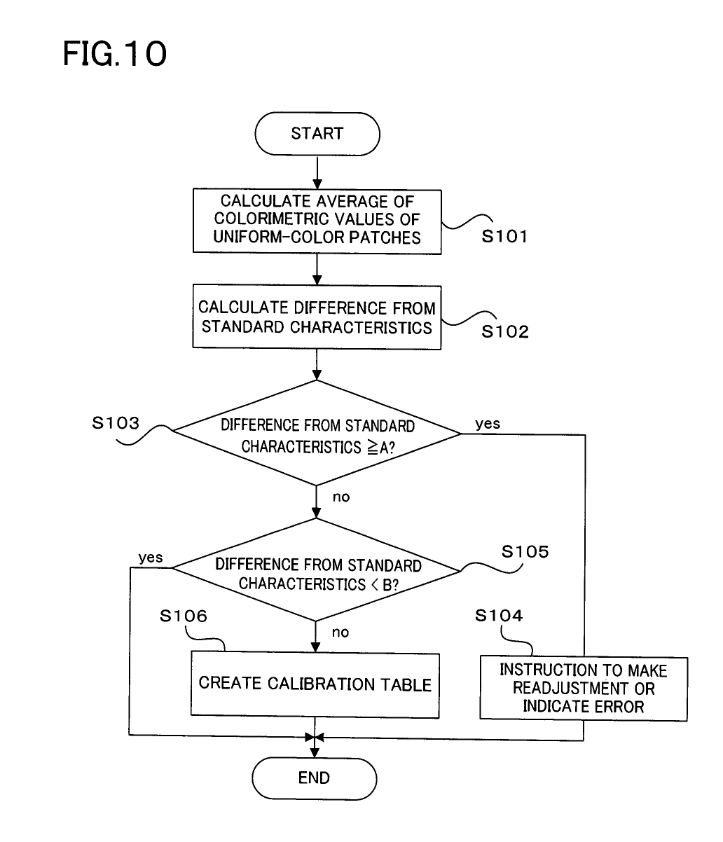

Then, a method for creating a calibration table based on measured calorimetric values of the patches of plural color test patterns positioned in this way is described with reference to a flowchart of FIG. 10.

First, grayscale characteristics of the patches of color test patterns printed on the printing paper are measured with the calorimeter 70 and the measured calorimetric values are input to the calibration device 30. Then, the calibration execution determining part 38 calculates an average of the calorimetric values of the patches each having a uniform color (step S101).

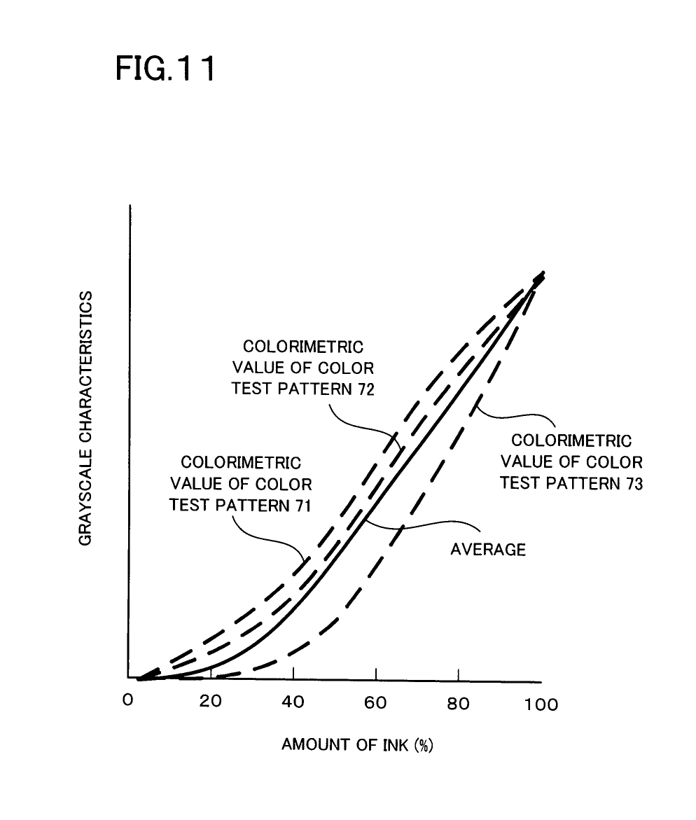

If, for example, three color test patterns 71, 72, 73 are printed on the printing paper, as illustrated in FIG. 7, an average of the calorimetric value of a color test pattern 71, the colorimetric value of a color test pattern 72, and the colorimetric value of a color test pattern 73 is calculated, as illustrated in FIG. 11. This average value is treated as an actual printing characteristic of the color. The average value as represented in FIG. 11 is calculated for each of CMYK colors, for example.

Next, the calibration execution determining part 38 calculates a difference between the calculated average calorimetric value and the standard characteristic data stored in the standard characteristic data storing part 37 (step S102). Then, the calibration execution determining part 38 determines whether the calculated difference from the standard characteristics is equal to or greater than a preset value A (S103). If the difference from the standard characteristics is equal to or greater than the value A, as determined at step S103, the calibration execution determining part 38 issues an instruction to make readjustment to the print engine 20 or an instruction to indicate an error to the user (S104).

If the difference from the standard characteristics is less than the value A, as determined at step S103, the calibration execution determining part 38 determines whether the difference from the standard characteristics is less than a preset value B (S105). If the difference from the standard characteristics is less than the value B, as determined at step S105, the calibration execution determining part 38 regards calibration as unnecessary because there is just a small difference from the standard characteristics, determines that calibration is unnecessary, and terminates the process.

If the difference from the standard characteristics is equal to or greater than the value B, as determined at step S105, the calibration execution determining part 38 determines that calibration should be executed and the calibration table creating part 36 creates a calibration table based on the colorimetric values measured with the colorimeter 70 (S106).

In the image forming system of the present exemplary embodiment, based on paper size information from the print engine 20, plural color test patterns are output in some positions on the printing paper where prints are expected to have different printing characteristics in the width direction of paper and the paper transport direction. Calibration is executed, based on an average of colorimetric values of the patches of the output plural color test patterns. Thus, calibration with a high accuracy can be executed without being affected by color non-uniformity even if various sizes of printing paper are used.

Further, in the image forming system of the present exemplary embodiment, calibration is not executed if there is too large or, conversely, too small a difference between an average of the calorimetric values of plural patches, each of which should be a uniform color, and the standard characteristics. In this way, it is possible to avoid calibration having an adverse effect on the printing characteristics and unnecessary calibration.

### Second Exemplary Embodiment

Next, an image forming system according to a second exemplary embodiment of the invention is described. The structure of the image forming apparatus in the second exemplary embodiment of the invention is substantially the same as the structure of the image forming apparatus in first exemplary embodiment shown in FIG. 3 and, therefore, its explanation is not repeated.

In the foregoing first exemplary embodiment, color test patterns in which each one patch has a uniform color are used. In the second exemplary embodiment of the invention, a distinct point from the foregoing exemplary embodiment is that calibration is executed using a color test pattern or patterns in which plural patches have a uniform color. In fact, the color test pattern generating part 31 mentioned in FIG. 3 generates a color test pattern in which plural patches have a uniform color and stores it into the color test pattern storing part 32.

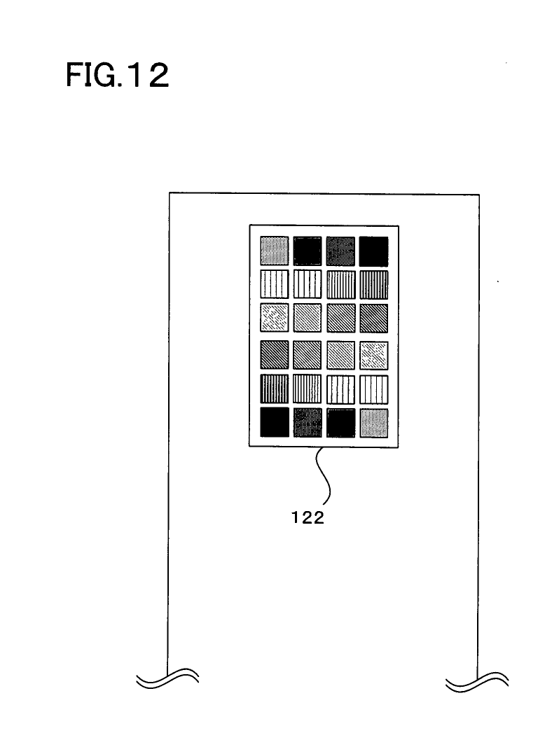

An example of a color test pattern used in the image forming system of the present exemplary embodiment is shown in FIG. 12. In this example shown in FIG. 12, the color test pattern 122 in which two patches each have a uniform color is illustrated.

Even when calibration is executed using the color test pattern in which plural patches have a uniform color as shown in FIG. 12, the process for creating a calibration table, including calculating an average of calorimetric values of plural patches having a uniform color included in the color test pattern printed on the printing paper and determining whether to execute calibration, is the same as described in the foregoing first exemplary embodiment.

The color test pattern print position setting part 33 in the present exemplary embodiment may set positions where plural color test patterns are printed respectively or only a position where a single color test pattern is printed, depending on paper size supplied from the print engine 20.

In the image forming system of the present exemplary embodiment, because plural patches have a uniform patch in one color test pattern, the printing characteristics in plural regions can be measured even if only one color test pattern is output on the printing paper. Additionally, influence of the positions of the patches arranged in a color test pattern on measurement results can be reduced. In a case where a color test pattern in which each one color patch has a uniform color is only used, if, for example, magenta patches are arranged in the leftmost column in the color test pattern, magenta color measurements always reflect the printing characteristics in the left end portion of printing paper. By use of the magenta color patches, it is hard to measure the printing characteristics in the right end portion of printing paper. On the other hand, if plural patches has a uniform color in one color test pattern, the patches with a uniform color exist in plural places within the color test pattern and, therefore, the influence of the positions of the patches in the color test pattern on measurement results is reduced. In this case, as a matter of course, the patches with a uniform color may be positioned as far apart from each other as possible within the pattern.

The color test pattern generating part 31 may generate plural color test patterns, in each of which patches are arranged differently. Thus, plural color test patterns with different arrangements of patches may be output on printing paper when these patterns are output on the printing paper.

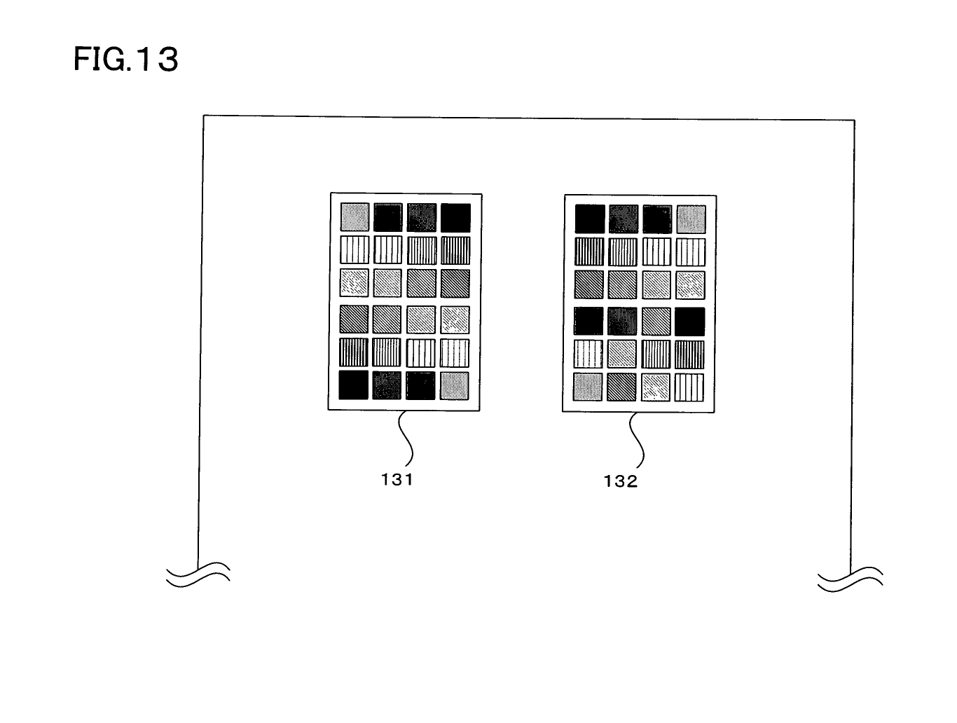

An example of prints of two color test patterns 131, 132 having different arrangements of patches on printing paper is shown in FIG. 13. In the example shown in FIG. 13, the arrangement of patches in a color test pattern 131 differs from the arrangement of patches in a color test pattern 132. By executing calibration using plural color test patterns having different arrangements of patches, as illustrated, the influence of the positions of the patches within a color test pattern on measurement results can be made smaller than in the case of using plural color test patterns, each having the same arrangement of patches. However, a task is added to prepare plural definitions of color test patterns to be measured with the calorimeter 70 due to different arrangements of patches for each color test pattern.

The present invention may be embodied in other specific forms without departing from its spirit or characteristics. The described exemplary embodiments are to be considered in all respects only as illustrated and not restrictive. The scope of the invention is, therefore, indicated by the appended claims rather than by the foregoing description. All changes which come within the meaning and range of equivalency of the claims are to be embraced within their scope.

What is claimed is:

1. An image forming system comprising:
a storing unit that stores a color test pattern made up of a set of test images for grayscale characteristic measurement;
a print position setting unit that sets a plurality of positions where the color test pattern stored in the storing unit is printed, based on paper size information supplied thereto;
an outputting unit that outputs the color test pattern retrieved from the storing unit in a plurality of positions on a printing medium according to the print positions set by the print position setting unit;
a grayscale correction data creating unit that creates grayscale correction data according to results of calorimetric measurements of the test images of a plurality of color test patterns printed on the printing medium; and
a grayscale characteristic correction unit that corrects grayscale characteristics of print data to be printed, according to the grayscale correction data created by the grayscale correction data creating unit.

2. An image forming system comprising:
a storing unit that stores a color test pattern made up of a set of test images for grayscale characteristic measurement, a plurality of test images having a uniform color in the color test pattern;
a print position setting unit that sets a position where the color test pattern stored in the storing unit is printed, based on paper size information supplied thereto;
an outputting unit that outputs the color test pattern retrieved from the storing unit on a printing medium according to the print position set by the print position setting unit;
a grayscale correction data creating unit that creates grayscale correction data according to results of calorimetric measurements of each plurality of test images having a uniform color included in the color test pattern printed on the printing medium; and
a grayscale characteristic correction unit that corrects grayscale characteristics of print data to be printed, according to the grayscale correction data created by the grayscale correction data creating unit.

3. The image forming system according to claim 2,
wherein the storing unit stores a plurality of color test patterns, in each of which test images are arranged differently, and
the print position setting unit sets print positions where the plurality of color test patterns having different arrangements of test images are printed on the printing medium, when setting the print positions for the plurality of color test patterns.

4. The image forming system according to claim 1, wherein the print position setting unit sets print positions so that color test patterns are printed in a plurality of print positions where prints are expected to have different printing characteristics.

5. The image forming system according to claim 1, wherein the print position setting unit sets print positions for color test patterns so that more color test patterns are printed in proportion as paper size becomes larger.

6. The image forming system according to claim 1, wherein the print position setting unit sets print positions for color test patterns so that printing characteristics in different positions across a width direction of paper will be measured.

7. The image forming system according to claim 1, wherein the print position setting unit sets print positions for color test patterns so that printing characteristics in different positions in a paper transport direction will be measured.

8. The image forming system according claim 1, wherein, if regions of color test patterns and region of a subsequent color test pattern in the paper transport direction overlap across a width of paper, the print position setting unit positions a subsequent color test pattern after a certain interval from preceding patterns overlapping with the subsequent color test pattern across the width of paper, the interval being larger than a printing cycle of a print mechanism part.

9. The image forming system according to claim 1, further comprising a determining unit that determines whether to execute grayscale correction, based on results of colorimetric measurements of a plurality of test images, each of which should be a uniform color,
wherein the grayscale correction data creating unit creates grayscale correction data, if the determining unit determines that grayscale correction should be executed.

10. The image forming system according to claim 9, wherein the determining unit determines that grayscale correction should not be executed, if an average of calorimetric values of the test images of a plurality of color test patterns is equal to or greater than a predetermined value.

11. The image forming system according to claim 9, wherein the determining unit determines that grayscale correction should not be executed, if an average of calorimetric values of the test images of a plurality of color test patterns is equal to or greater than a predetermined first value or less than a predetermined second value.

12. The image forming system according to claim 1, further comprising a determining unit that determines that grayscale correction should not be executed, if a difference across the colorimetric values of a plurality of test images, each of which should be a uniform color, is equal to or greater than a predetermined value,
wherein the grayscale correction data creating unit creates grayscale correction data, if the determining unit determines that grayscale correction should be executed.

13. The image forming system according to claim 9, wherein, upon determining that grayscale correction should not be executed, the determining unit issues an instruction to make readjustment to the print mechanism part.

14. The image forming system according to claim 9, wherein, upon determining that grayscale correction should not be executed, the determining unit issues an instruction to indicate an error on display, informing that some fault has occurred in the print mechanism part.

15. A grayscale characteristics correcting method comprising:
setting a plurality of positions where the color test pattern made up of a set of test images for grayscale characteristic measurement is printed, based on paper size information supplied thereto;
outputting the color test pattern in the plurality of positions on a printing medium according to the print positions;
creating grayscale correction data according to results of calorimetric measurements of the test images of a plurality of color test patterns printed on the printing medium; and
correcting grayscale characteristics of print data to be printed, according to the grayscale correction data.

16. A grayscale characteristics correcting method comprising:
setting a plurality of positions where the color test pattern made up of a set of test images for grayscale characteristic measurement, a plurality of test images having a uniform color in the color test pattern is printed, based on paper size information supplied thereto;
outputting the color test pattern in the plurality of positions on a printing medium according to the print positions;
creating grayscale correction data according to results of calorimetric measurements of the test images of a plurality of color test patterns printed on the printing medium; and
correcting grayscale characteristics of print data to be printed, according to the grayscale correction data.
